(19) United States
(12) Patent Application Publication
(10) Pub. No.: US 2026/0011915 A1
(43) Pub. Date: Jan. 8, 2026

(54) MULTI-BEAM 3-DIMENSIONAL METASURFACE LENS FOR HIGH CAPACITY SITES

(71) Applicant: Amphenol Antenna Solutions, Inc., Conover, NC (US)

(72) Inventors: Jimmy Ho, Hickory, NC (US); Erik Reinier Thijssen, Tours (FR); Anthony Pallone, Civray-de-Touraine (FR); Cyrille Leblanc, Pocé-sur-Cisse (FR); Eric Proteau, Mosnes (FR); Thomas Hardy, Montlouis-sur-Loire (FR); Lance Darren Bamford, Pittsford, NY (US); Minya Gavrilovic, Wepean (CA)

(73) Assignee: Amphenol Antenna Solutions, Inc., Conover, NC (US)

(21) Appl. No.: 19/261,620

(22) Filed: Jul. 7, 2025

Related U.S. Application Data
(60) Provisional application No. 63/668,624, filed on Jul. 8, 2024.

(51) Int. Cl. H01Q 3/36; H01Q 1/24

(52) U.S. Cl. CPC H01Q 3/36; H01Q 1/246

(57) ABSTRACT

An antenna device includes a radiating structure configured to transmit and/or receive electromagnetic waves in a first direction, and a lens substrate spaced from the radiating structure in the first direction and including an aperture therein aligned, at least in part, with the radiating structure along the first direction and a surface having conductive material thereon configured to apply a phase shift to electromagnetic waves to and/or from the radiating structure passing therethrough. Some embodiments include multiple lens substrates spaced from one another and from the radiating structure, each lens substrate having an aperture therein aligned at least in part with the radiating structure along the first direction and a surface having conductive material thereon. In some embodiments, the aperture is aligned in part with the radiating structure along the first direction and is offset from the radiating structure in a direction perpendicular to the first direction.

### CROSS-REFERENCE TO RELATED APPLICATIONS

This application claims priority to and the benefit under 35 U.S.C. § 119(e) of U.S. Provisional Application No. 63/668,624, filed on Jul. 8, 2024, entitled “MULTI-BEAM 3-DIMENSIONAL METASURFACE LENS FOR HIGH CAPACITY SITES.” The contents of these applications are incorporated herein by reference in their entirety.

### FIELD OF THE DISCLOSURE

The disclosure relates to antennas, and in particular, to the configuration and application of a metasurface lens for high capacity sites. Some embodiments of the present disclosure provide low-cost, lightweight 3D metasurface lens antenna devices capable of providing multi-beam solutions with well controlled sidelobes for high capacity network cells, enabling a crowd of users to enjoy a seamless digital experience.

### BACKGROUND

The advent of cellular radio systems has seen a great demand for base station antennas deployed in many different network scenarios. Some new emerging features are narrow beam antennas with low sidelobes to be deployed in crowded environments. For example, during major sporting events in a stadium, sports fans are using sophisticated apps requiring very high bandwidth to enjoy a digital experience. Thus, bandwidth demand is increasing, which demands a new class of base station antennas with very narrow beamwidths with very well controlled sidelobes to mitigate interference between adjacent cells.

### SUMMARY

According to a non-limiting embodiment, an antenna device includes a first radiating structure configured to transmit and/or receive electromagnetic waves in a first direction, a second radiating structure spaced from the first radiating structure in a second direction perpendicular to the first direction and configured to transmit and/or receive electromagnetic waves in the first direction, and a lens substrate spaced from the first radiating structure and from the second radiating structure in the first direction. The lens substrate may include an aperture therein aligned, at least in part, with the first radiating structure along the first direction and aligned, at least in part, with the second radiating structure along the first direction. The lens substrate may further include a surface having conductive material thereon configured to apply a phase shift to electromagnetic waves to and/or from the first radiating structure and to and/or from the second radiating structure passing therethrough.

In some additional or alternative embodiments, the aperture may be aligned, in part, with the first radiating structure along the first direction and offset from the first radiating structure along a third direction that is perpendicular to the first direction, and the aperture may be aligned, in part, with the second radiating structure along the first direction and offset from the second radiating structure along a fourth direction that is perpendicular to the first direction.

In some additional or alternative embodiments, the first radiating structure and the second radiating structure may be configured to transmit and/or receive electromagnetic waves at a first frequency, a center of the aperture may be offset from a center of the first radiating structure in the third direction by a first offset distance that is at least one-quarter wavelength at the first frequency and less than one-half wavelength at the first frequency, and the center of the aperture may be offset from a center of the second radiating structure in the fourth direction by a second offset distance that is at least one-quarter wavelength at the first frequency and less than one-half wavelength at the first frequency.

In some additional or alternative embodiments, the aperture may have a diameter between 0.4 wavelengths and 0.6 wavelengths at the first frequency.

In some additional or alternative embodiments, the aperture may comprise a void in the lens substrate.

In some additional or alternative embodiments, the conductive material may comprise conductive elements configured to apply respective phase shifts to electromagnetic waves passing through the conductive material, the phase shifts increasing with distance from the conductive element to the aperture.

In some additional or alternative embodiments, the first radiating structure may be configured to transmit and/or receive electromagnetic waves along a first axis in the first direction, the second radiating structure may be configured to transmit and/or receive electromagnetic waves along a second axis in the first direction, the conductive material may be configured to apply the phase shift to steer the electromagnetic waves transmitted and/or received by the first radiating structure at a first angle with respect to the first axis, and the conductive material may be configured to apply the phase shift to steer the electromagnetic waves transmitted and/or received by the second radiating structure at a second angle with respect to the second axis.

In some additional or alternative embodiments, the antenna device may further comprise a second lens substrate spaced from the lens substrate in the first direction and comprising a second aperture therein aligned, at least in part, with the first radiating structure along the first direction and aligned, at least in part, with the second radiating structure along the first direction, and a second surface having conductive material thereon configured to apply a phase shift to electromagnetic waves to and/or from the first radiating structure and to and/or from the second radiating structure passing therethrough.

According to a non-limiting embodiment, an antenna device includes a radiating structure configured to transmit and/or receive electromagnetic waves in a first direction, a first lens substrate spaced from the radiating structure in the first direction, and a second lens substrate spaced from the first lens substrate in the first direction. The first lens substrate may comprise a first aperture therein aligned, at least in part, with the radiating structure along the first direction, and a first surface having conductive material thereon configured to apply a phase shift to electromagnetic waves to and/or from the radiating structure passing therethrough. The second lens substrate may comprise a second aperture therein aligned, at least in part, with the radiating structure along the first direction, and a second surface having conductive material thereon configured to apply a phase shift to electromagnetic waves to and/or from the radiating structure passing therethrough.

In some additional or alternative embodiments, the first aperture may comprise a void in the first lens substrate and the second aperture may comprise a void in the second lens substrate.

In some additional or alternative embodiments, the conductive material on the first surface may comprise conductive elements configured to apply respective phase shifts to electromagnetic waves passing through the conductive material, the phase shifts increasing with distance from the conductive element to the first aperture, and the conductive material on the second surface may comprise conductive elements configured to apply respective phase shifts to electromagnetic waves passing through the conductive material, the phase shifts increasing with distance from the conductive element to the second aperture.

In some additional or alternative embodiments, the conductive material on the second surface may comprise more conductive elements than the conductive material on the first surface.

In some additional or alternative embodiments, the conductive elements of the conductive material on the first surface may be arranged in a first plurality of rings that are concentric with the first aperture, the conductive elements of the conductive material on the second surface may be arranged in a second plurality of rings that are concentric with the second aperture, and the second plurality of rings may be greater in number than the first plurality of rings.

In some additional or alternative embodiments, the antenna device may further comprise a third lens substrate spaced from the second lens substrate in the first direction and comprising a third aperture therein aligned, at least in part, with the radiating structure along the first direction, and a third surface having conductive material thereon that comprises conductive elements configured to apply respective phase shifts to electromagnetic waves passing through the conductive material, the phase shifts increasing with distance from the conductive element to the third aperture, wherein the conductive material on the second surface comprises more conductive elements than the conductive material on the third surface.

According to a non-limiting embodiment, an antenna device may comprise a radiating structure configured to transmit and/or receive electromagnetic waves in a first direction, and a lens substrate spaced from the radiating structure in the first direction. The lens substrate may comprise an aperture therein aligned, in part, with the radiating structure along the first direction and offset, in part, from the radiating structure in a second direction perpendicular to the first direction, and a surface having conductive material thereon configured to apply a phase shift to electromagnetic waves to and/or from the radiating structure passing therethrough.

In some additional or alternative embodiments, the radiating structure may be configured to transmit and/or receive electromagnetic waves along a first axis in the first direction, and the conductive material may be configured to apply the phase shift to steer the electromagnetic waves at an angle with respect to the first axis.

In some additional or alternative embodiments, the radiating structure may be configured to transmit and/or receive electromagnetic waves at a first frequency, and a center of the aperture may be offset from a center of the radiating structure in the second direction by an offset distance that is at least one-quarter wavelength at the first frequency and less than one-half wavelength at the first frequency.

In some additional or alternative embodiments, the aperture may have a diameter between 0.4 wavelengths and 0.6 wavelengths at the first frequency.

In some additional or alternative embodiments, the aperture may comprise a void in the lens substrate.

In some additional or alternative embodiments, the conductive material comprises conductive elements configured to apply respective phase shifts to electromagnetic waves passing through the conductive material, the phase shifts increasing with distance from the conductive element to the aperture.

In some additional or alternative embodiments, the antenna device may further comprise a second lens substrate spaced from the lens substrate in the first direction and comprising a second aperture therein aligned, in part, with the radiating structure along the first direction and offset, in part, from the radiating structure in the second direction, and a second surface having conductive material thereon configured to apply a phase shift to electromagnetic waves to and/or from the radiating structure passing therethrough.

### BRIEF DESCRIPTION OF THE DRAWINGS

FIG. 1 shows a crossed dipole radiating element in front of a planar conductive reflector, according to one or more non-limiting embodiments of the present disclosure.

FIG. 2A shows an example of a metasurface lens substrate in accordance with one or more non-limiting embodiments of the present disclosure, which includes a plurality of substantially square conductive scattering elements arranged in concentric circles.

FIG. 2B shows another example of a metasurface lens substrate in accordance with one or more non-limiting embodiments of the present disclosure, which includes a plurality of substantially square conductive scattering elements arranged in concentric squares.

FIG. 3A shows a representation of wave fronts as they propagate from a source through several layers of a metasurface lens using conductive scattering elements on each layer according to one or more non-limiting embodiments of the present disclosure.

FIG. 3B shows resulting radiation of the configuration of FIG. 3A, according to one or more non-limiting embodiments of the present disclosure.

FIG. 4A shows a representation of wave fronts as they propagate from a source through several layers of a metasurface lens using identical sets of conductive scattering elements on each layer according to one or more non-limiting embodiments of the present disclosure.

FIG. 4B shows a resulting radiation pattern of FIG. 4A, according to one or more non-limiting embodiments of the present disclosure.

FIG. 5A shows an example of a metasurface lens applied to one side of a dipole arm to provide a squint or tilt off boresight, according to one or more non-limiting embodiments of the present disclosure.

FIG. 5B shows a resulting radiation pattern of the arrangement of FIG. 5A, according to one or more non-limiting embodiments of the present disclosure.

FIG. 6A shows a representation of the input and output wavefronts as they propagate from a source that has been offset by at least ¼ wavelength from the focal axis of the lens to enable the beam to tilt off axis, according to one or more non-limiting embodiments of the present disclosure.

FIG. 6B shows a resulting radiation pattern of FIG. 6A where the output beam has been tilted +13° off axis, according to one or more non-limiting embodiments of the present disclosure.

FIG. 7A shows a representation of the input and output wavefronts of two radiating elements excited concurrently and separated equally in opposite directions from the focal axis of the lens, according to one or more non-limiting embodiments of the present disclosure.

FIG. 7B shows resulting radiation patterns of FIG. 7A including two output beams with one tilted at +11° and one tilted at −11° off axis, according to one or more non-limiting embodiments of the present disclosure.

FIG. 7C shows a resulting sharp rolloff radiation pattern by combining the two beams from FIG. 7B, according to one or more non-limiting embodiments of the present disclosure.

FIG. 7D shows a top view of FIG. 7A, according to one or more non-limiting embodiments of the present disclosure.

FIG. 8A shows a top view of the radiating elements and FIG. 8B shows the corresponding spot beam produced due to the location of those radiating elements, according to one or more non-limiting embodiments of the present disclosure.

FIG. 9A shows an antenna configuration that operates across a frequency band of 3300-4000 MHz to achieve a narrow beamwidth, low sidelobe and high gain 3-dimensional (3D) metasurface lens antenna for high capacity sites, according to one or more non-limiting embodiments of the present disclosure.

FIG. 9B shows a top view of the configuration FIG. 9A, according to one or more non-limiting embodiments of the present disclosure.

FIG. 9C shows a side view of the configuration of FIG. 9A, according to one or more non-limiting embodiments of the present disclosure.

FIG. 9D shows various metasurface lenses of the configuration of FIG. 9A, according to one or more non-limiting embodiments of the present disclosure.

FIG. 9E shows simulated co-polarized and cross polarized radiation pattern of the configuration of FIG. 9A at 3900 MHz or 3.9 GHz, according to one or more non-limiting embodiments of the present disclosure.

FIG. 9F shows measured co-polarized and cross polarized radiation pattern of the configuration of FIG. 9A at 3900 MHz or 3.9 GHz, according to one or more non-limiting embodiments of the present disclosure.

FIG. 9G shows simulated and measured values of the azimuth beamwidth across frequency of the configuration of FIG. 9A, according to one or more non-limiting embodiments of the present disclosure.

FIG. 9H shows measured gain of the antenna configuration of FIG. 9A, according to one or more non-limiting embodiments of the present disclosure.

FIG. 10 shows an antenna with four elements placed under a 3D metasurface lens assembly to produce four concurrent high gain beams with well controlled radiation patterns, according to one or more non-limiting embodiments of the present disclosure.

### DETAILED DESCRIPTION

Most modern mobile radio networks are planned using base station antennas having a directional azimuth radiation pattern with a nominal half-power azimuth beamwidth Such beamwidth may be specified between 60° and 65°. A single base station antenna may include a vertical column of dual-polar radiating elements, transmitting and receiving signals with linear polarizations inclined ±45 degrees to the vertical. Antenna arrays may include a plurality of radiating structures, such as crossed dipoles and patches, mounted in front of a reflector.

In some embodiments of the present disclosure, one or more metasurface lens elements, may be placed in front of an antenna element or radiating structure. Such a metasurface lens element or elements may be configured to focus energy radiated from the antenna element(s) or radiating structure(s), reducing the beamwidth provided by the antenna element(s) or radiating structure(s) as compared to without the lens, thereby increasing overall gain. In an exemplary embodiment, metasurface lenses described herein may include (e.g., predominantly) dielectric materials, for example polyethylene. It is recognized that, while most of the energy impinging on the lens may be transmitted through the lens in a forward beam (or received through the lens in a rearward beam), some energy may be reflected by surfaces of the lens and the reflected power could interfere with the impedance presented by the antenna element or radiating structure to its feed line.

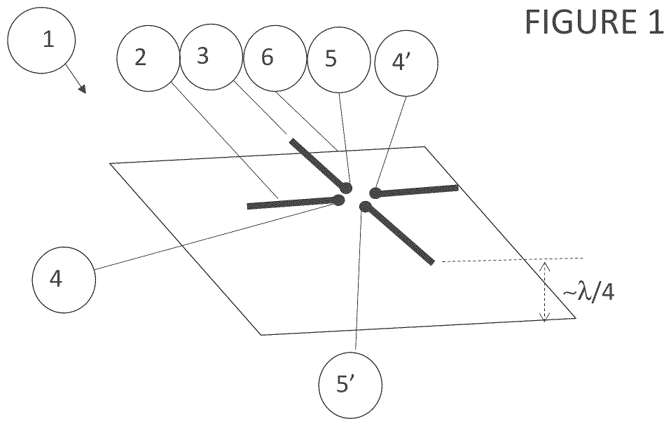

FIG. 1 shows a crossed dipole radiating element in front of a planar conductive reflector, according to one or more non-limiting embodiments of the present disclosure.

With reference to FIG. 1, an antenna element 1 may, for example, include a dipole or crossed dipole radiating element 2, 3, spaced (e.g., by approximately a quarter-wavelength at an operating frequency) from a conductive planar reflector 6 and excited by providing (e.g., feeding) a signal between pairs of terminals 4, 4′ and 5, 5′. It should be appreciated that, by reciprocity, a signal may be fed between pairs of terminals 4, 4′ and 5, 5′ for transmission or reception via the antenna element 1. In some embodiments, the antenna element 1 may be configured to radiate with low directivity (e.g., substantially unidirectionally).

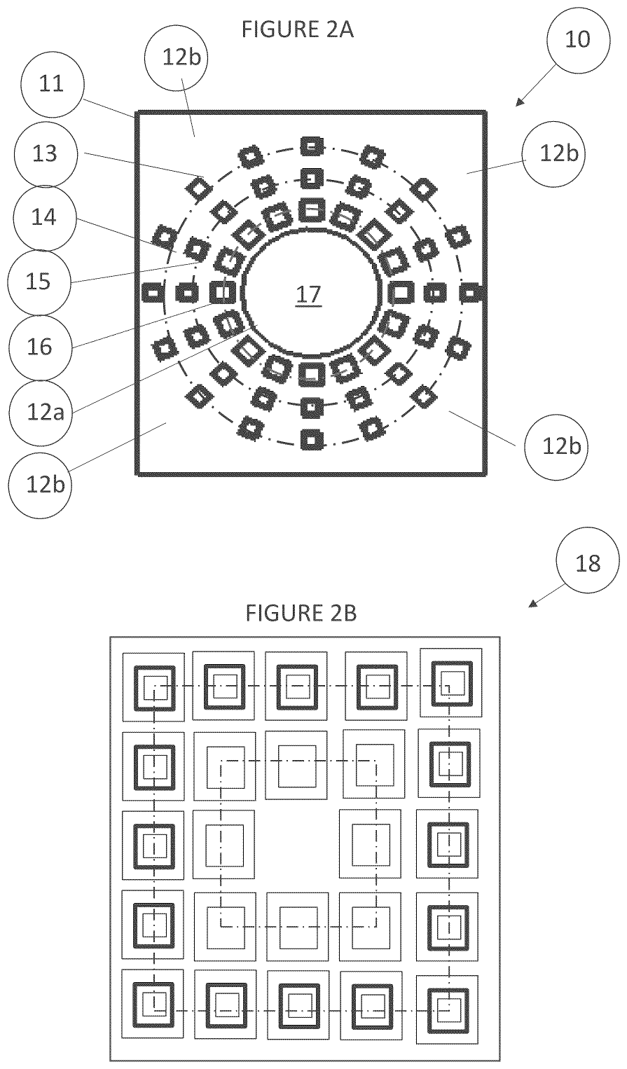

FIGS. 2A & 2B show respective examples of a metasurface lens substrate. FIG. 2A shows an example of a metasurface lens substrate in accordance with one or more non-limiting embodiments of the present disclosure, which includes a plurality of substantially square conductive scattering elements arranged in concentric circles. . . . FIG. 2B shows an example of a metasurface lens substrate 18 in accordance with one or more non-limiting embodiments of the present disclosure, which includes a plurality of substantially square conductive scattering elements arranged in concentric circles. It should be appreciated that description herein in connection with FIG. 2A is applicable to FIG. 2B and vice versa.

In the illustrated examples of FIGS. 2A and 2B, the metasurface lens substrate has an aperture (e.g., 17) therein and a surface having conductive material (e.g., conductive elements 13) thereon. As described further below, the conductive material may be configured to apply a phase shift to electromagnetic waves passing therethrough. In some embodiments, a metasurface lens substrate configured in this manner may be advantageously spaced from a radiating structure (e.g., antenna element 1 in FIG. 1) to apply a phase shift to electromagnetic waves to and/or from the radiating structure, which may narrow the beamwidth and thus increase directivity of the radiating structure as compared to without the lens substrate.

In FIG. 2A, a metasurface lens 10 may include a lens substrate (e.g., lamina) 11 that includes a first surface, a second surface opposite the first surface, a first, axial region 12a, and a second, non-axial region 12b surrounding the axial region 12a. In some embodiments, the lens substrate 11 may be formed using one or more suitable dielectric materials such as fiberglass or glass epoxy laminate.

In some cases, an antenna element or radiating structure may have a directional radiating pattern (e.g., even if directivity is low) having a maximum directivity along an axis such that more power is radiated along the axis than in any particular off-axis direction. Of course, an antenna element or radiating structure may have multiple axes of maximum directivity, for instance, when evaluated in a single plane (e.g., azimuth or elevation) as opposed to in 3-D space.

In some embodiments, the metasurface lens substrate may include conductive material on a surface thereof. In FIG. 2A, the metasurface lens 10 further includes a plurality of conductive scattering elements 13 on a surface of the lens substrate 11. The conductive scattering elements 13 may include one or more suitable metal materials such as copper. According to a non-limiting embodiment, the conductive scattering elements 13 may have a substantially square profile and may be arranged in concentric circles 14, 15, 16 surrounding the axial region 12a. It should be appreciated that the profile of the conductive scattering elements 13 can have other shapes without departing from the scope of the disclosure. Moreover, the conductive scattering elements may be arranged in concentric rings of non-circular shape, such as the concentric square (e.g., cartesian) rings illustrated in FIG. 2B.

In some embodiments, the lens substrate 11 may include an aperture. In FIG. 2A, an aperture 17 is located proximate a focal axis of the lens 10 at a center of the lens substrate. According to a non-limiting embodiment, the axial region 12a may include the aperture 17, which may include a void in the lens substrate 11. In some embodiments, the axial region 12a may alternatively or additionally include portions of the lens substrate 11 wherein no conductive scattering elements 13 are present.

As described herein, the axial region 12a includes the region of the lens 10 that is aligned, at least in part, with an axis of maximum directivity of a radiating element (e.g., source antenna) in a direction in which the radiating element is configured to radiate electromagnetic waves. For example, the axial region 12a may be a region proximate a focal axis of the lens 10,, and the non-axial region 12b may be a region at least partially surrounding the axial region 12a about the focal axis of the lens 10. In one or more non-limiting embodiments, the axial region 12a may be configured to receive a first portion of the electromagnetic waves and/or a first group of electromagnetic waves (e.g., including waves propagating along the direction of maximum directivity), and the non-axial region 12b may be configured to receive a second portion of the electromagnetic waves and/or a second group of electromagnetic waves (e.g., including waves propagating along directions having less than maximum directivity).

While the examples shown in FIGS. 2A and 2B include symmetrical arrangements of conductive scattering elements, asymmetric arrangements are also possible and may be advantageous, e.g., when the source antenna has an asymmetric radiating pattern. For example, an antenna may include a plurality of radiating elements disposed in an asymmetric arrangement. In this case, the lens can include an asymmetric arrangement of conductive scattering elements arranged corresponding to the asymmetric arrangement of radiating elements.

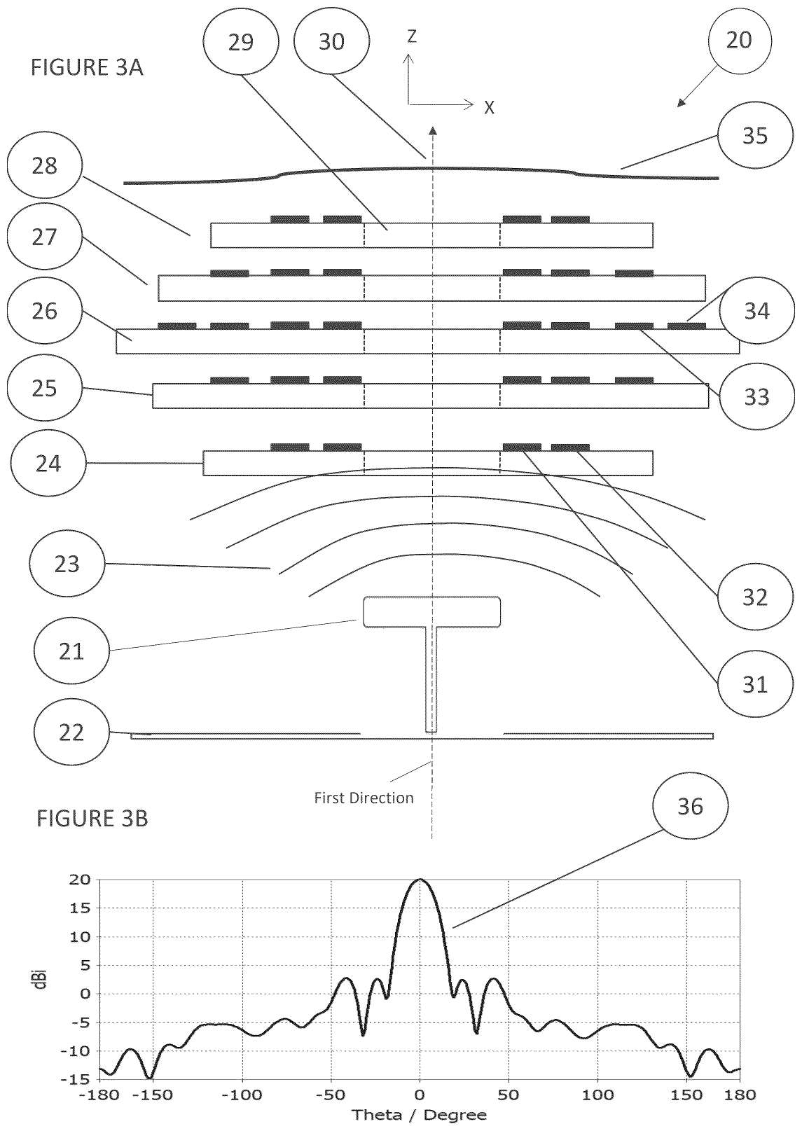

FIG. 3A shows a representation of wave fronts as they propagate from a source through several layers of a metasurface lens using conductive scattering elements on each layer according to one or more non-limiting embodiments of the present disclosure.

In some embodiments, an antenna device 20 (FIG. 3A) may include a radiating structure 21 and a lens substrate 24 spaced from the radiating substrate in a direction in which the radiating structure is configured to transmit and/or receive electromagnetic waves. For example, the lens substrate 24 may have conductive material on a surface thereon configured to apply a phase shift to electromagnetic waves to and/or from the radiating structure 21. In the example of FIG. 3A, the antenna device 20 includes a stack of several lens substrates 24, 25, 26, 27, and 28 spaced from one another and from the radiating structure 21, though it should be appreciated that any number of lens substrates, including a single lens substrate, may be used depending on the particular application.

In FIG. 3A, a radiating element 21 (e.g., a source antenna 21) is situated above a conductive reflector 22 and a succession of curved wave fronts 23 are shown propagating away from a radiating element 21. According to a non-limiting embodiment, the radiating element 21 may be configured to operate (e.g., transmit and/or receive electromagnetic waves) at a frequency greater than or equal to 0.5 gigahertz (GHz) and less than or equal to 100 GHz.

Metasurface lens, including lens substrates 24, 25, 26, 27, and 28, may be configured according to one or more non-limiting embodiments of the present disclosure. For example, each lens substrate shown in FIG. 3A includes an aperture 29 (e.g., about a focal axis of the metasurface lens 30) and conductive material on a surface thereof. In the illustrated example, the conductive material includes conductive scattering elements 31, 32, 33, 34 arranged to apply respective phase shifts to electromagnetic waves passing through the conductive material.

In some embodiments, the conductive elements may be configured to provide a phase advance of the wavefront as it passes through the lens substrates 24, 25, 26, 27, and 28. For example, the conductive elements may be configured to apply respective phase shifts that increase with distance from the conductive element to the aperture 29. In FIG. 3A, for example, the outer regions 33,34 of the lens substrate 26 may be configured to provide a larger degree of phase advance than the inner regions 31,32.

According to a non-limiting embodiment, the aperture 29 may have a size (e.g., diameter) that matches, or substantially matches, the size of the radiating aperture of the radiating element 21. For example, the aperture may have a diameter between 0.4 wavelengths and 0.6 wavelengths at a frequency at which the radiating element 21 is configured to transmit and/or receive electromagnetic waves. In some non-limiting embodiments, the aperture 29 is sized larger or smaller than the physical aperture f the radiating element 21.

In some embodiments, the aperture 29 may provide an impedance advantage. For example, the radiating element 21 may be configured with a small amount of reflection to the feedline due to imperfect impedance match, but the addition of a lens substrate (e.g., which may be a superstrate with respect to the radiating element) above the radiating element may result in increased reflections back towards the radiating element, impacting the input impedance of the radiating element. Since the relative phase of the reflections between the lens substrate and the radiating element is frequency-dependent, the input impedance of the radiating element may consequently vary in a frequency-dependent manner due, which is difficult to compensate and is likely to result in degraded performance of an array of radiating elements such as is used in a base station antenna. In this respect, for example, an aperture (and/or an area providing a low degree of scattering) aligned at least in part with the radiating element (e.g., in the axial region of the lens), may reduce power reflected by the lens as compared to without the aperture, resulting in only a small impact on the input impedance of the antenna device. Accordingly, a lens according to one or more non-limiting embodiments of the present disclosure may be included in an antenna device (e.g., with a pre-existing antenna device) without requiring significant re-tuning of the input impedance of the antenna device (e.g., where the input impedance was already tuned).

In some embodiments, an antenna device may include multiple lens substrates having different numbers of conductive elements and/or different numbers of rings of conductive elements from one another. For example, the number of conductive elements and/or rings of conductive elements may increase with distance from the radiating element, and/or may decrease with distance from the radiating element, such as by first increasing and then decreasing with distance from the radiating element. For instance, in FIG. 3A, the lens substrate 26 has more conductive elements and more rings of conductive elements than the lens substrate 25. Also, in the illustrated example, the lens substrate 26 has more conductive elements and more rings of conductive elements than the lens substrate 27. It should be appreciated that a lens substrate may alternatively have more conductive elements but not more rings of conductive elements, or more rings of conductive elements but not more conductive elements, than another lens substrate within the scope of the present aspects.

In some embodiments, the distribution of conductive elements on the lens substrates 24, 25, 26, 27, and 28 may be configured to approximate an ellipsoidal or spherical (e.g., dielectric) lens. In FIG. 3A, the metasurface lens 26 is centrally located within the lens substrate stack, and has more scattering elements than the upper and lower metasurface lens substrates 24, 25, 27, 28. Metasurface lens substrates 24, 28 have even fewer conductive scattering elements than metasurface lens substrates 25,27. This construction mimics closely a 3D spherical lens that adjusts phases of electromagnetic waves as the wavefront 23 travels through each metasurface lens substrate 24,25,26,27,28 such that the emerging wavefront 35 is reduced in curvature, or “flattened”. In some embodiments, metasurface lenses described herein, such as in FIG. 3A, effect a reduction in beamwidth of the radiation pattern compared to the radiating element without a lens, thereby increasing the directivity and gain of the radiating element. It will be understood that the number of rings of conductive scattering elements is not limited to as the configurations shown in FIG. 3A, but may be any chosen number.

FIG. 3B shows a radiation plot 36 with narrow beamwidth, high gain and low sidelobes resulting from the configuration of conductive scattering elements on the metasurface lens substrates 24, 25, 26, 27, 28.

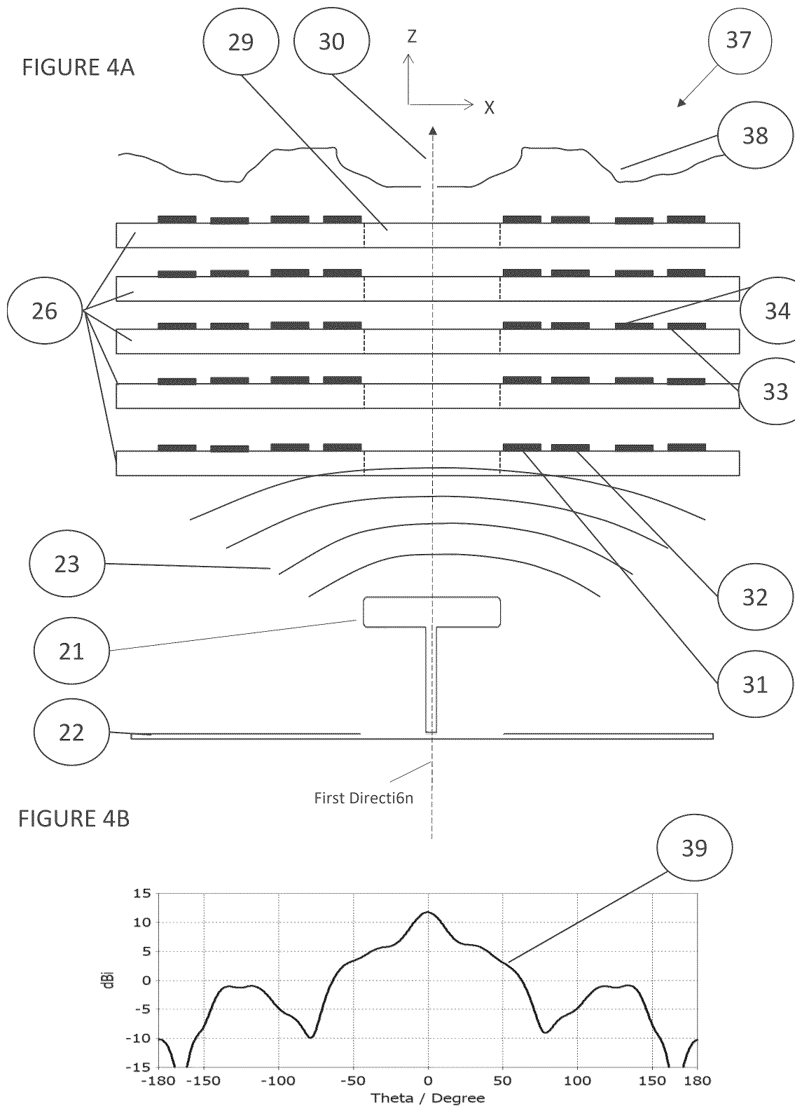

FIG. 4A shows an antenna device 37 having an alternative metasurface lens arrangement to FIG. 3A in which the scattering elements 31,32,33,34 on metasurface lens 26 are identically arranged on each lens substrate. In the illustrated example, the phase shifts provided by the lens substrates may be inappropriate for the radiating element of the antenna device, such that the emerging wavefront 38 does not have a reduced curvature but a random distribution. The resulting radiation pattern 39 has high sidelobes, low gain and both a wide beam and a small point beam with large shoulders as shown in FIG. 4B.

In the embodiments of antenna devices described above, one or more lens substrates may have an aperture aligned with a radiating structure. As a result of substantial or total alignment, an axis of maximum directivity of the radiating structure (and/or a phase center thereof) may be aligned with a focal axis of the lens. The antenna device may thus exhibit an axis of maximum directivity that is substantially or totally coincident with both the maximum directivity axis of the radiating structure and the focal axis of the lens.

In other embodiments described further herein, one or more lens substrates may have an aperture that is aligned in part with a radiating structure and offset from the radiating structure. As a result of the partial alignment and offset, an axis of maximum directivity of the radiating structure (and/or a phase center thereof) may be offset from a focal axis of the lens. The antenna device may thus exhibit an axis of maximum directivity that is at an angle relative to one or both of an axis of maximum directivity of the radiating structure and the focal axis of the lens. In some embodiments, the offset may cause the lens to advantageously steer electromagnetic waves to and/or from the radiating structure at an angle relative to an axis of maximum directivity of the radiating element.

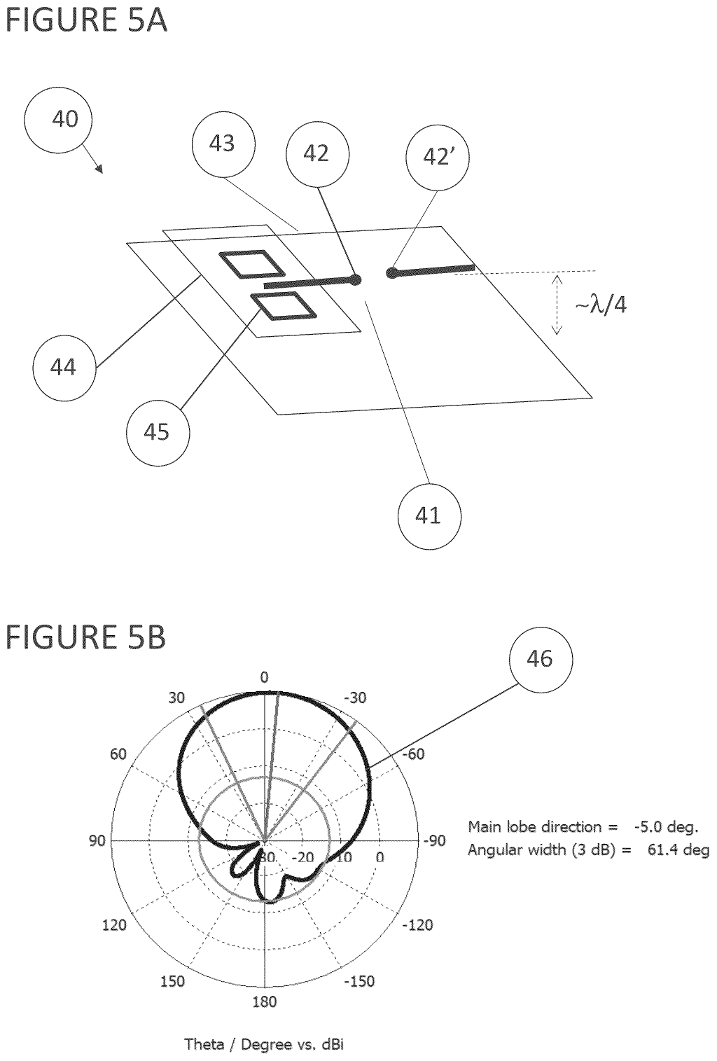

FIG. 5A shows an example of a metasurface lens applied to one side of a dipole arm to provide a squint or tilt off boresight, according to one or more non-limiting embodiments of the present disclosure. FIG. 5B shows a resulting radiation pattern of the arrangement of FIG. 5A, according to one or more non-limiting embodiments of the present disclosure.

FIG. 5A shows an offset (e.g., pre-tilted) radiating element arrangement 40. The radiating element arrangement 40 may include a cross dipole element such as shown in FIG. 1. With reference to FIG. 5A, the radiating element is thus shown as a single polarized dipole 41, which may be implemented alone or as part of a cross-dipole. The radiating element is above a reflector ground plane 43 and configured to be excited by providing a signal between pairs of terminals 42, 42′.

In some embodiments, a metasurface lens substrate may be aligned in part with the radiating element in a first direction and offset from the radiating element in a second direction perpendicular to the first direction. As shown in part in Figure. 5A, a metasurface lens 44 with conductive scattering elements 45 may be aligned with one dipole arm that is excited by a signal component at terminal 42. The metasurface lens is offset from the other dipole arm excited by another component of the signal at terminal 42′. Such an arrangement changes the phase of waves transmitted or received by one of the two dipole arms with respect to waves transmitted or received by the other dipole arm, resulting in a squint or tilt in the radiation pattern to one side of the dipole 41.

FIG. 5B shows the radiation pattern 46 with a squint or tilt of 5° as a result of having the metasurface lens 44 above only one dipole arm of the dipole 41.

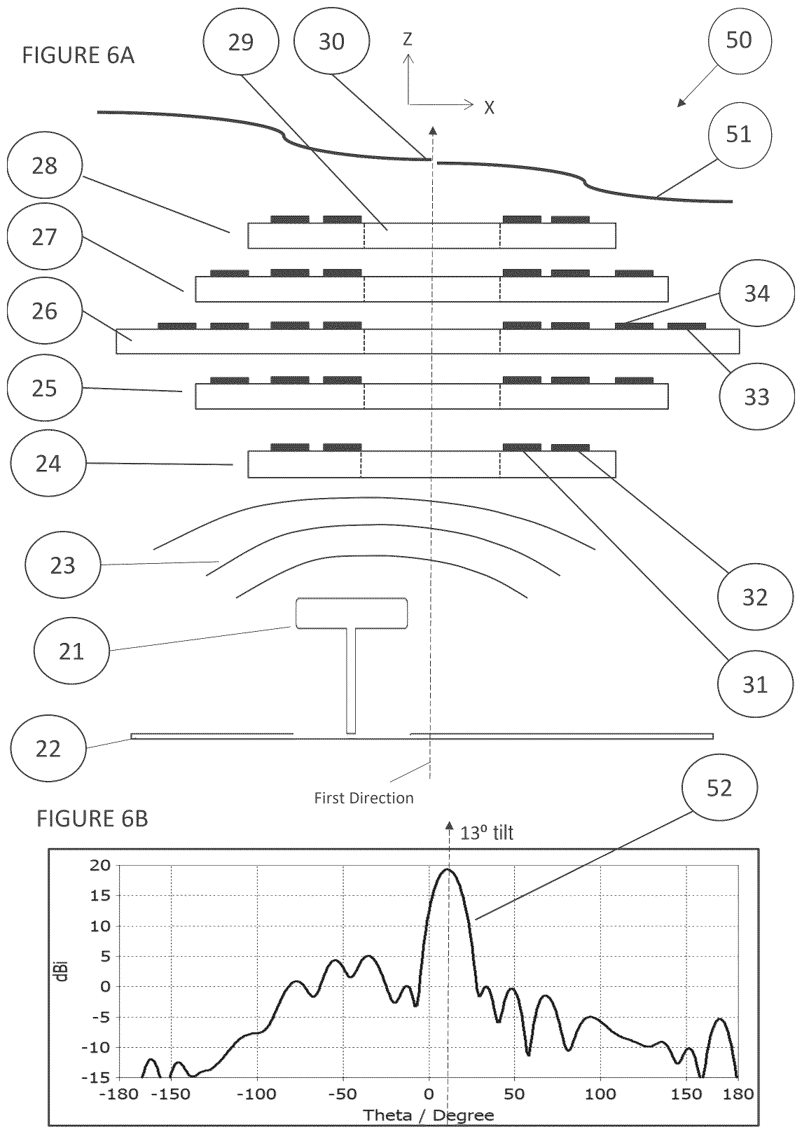

FIG. 6A shows a representation of the input and output wavefronts as they propagate from a source that has been offset by at least ¼ wavelength from the focal axis of the lens to enable the beam to tilt off axis, according to one or more non-limiting embodiments of the present disclosure. FIG. 6B shows a resulting radiation pattern of FIG. 6A where the output beam has been tilted +13° off axis, according to one or more non-limiting embodiments of the present disclosure.

In some embodiments, an antenna device may have a lens substrate (e.g., 24) having an aperture (e.g., 29) that is aligned, at least in part, with a radiating element (e.g., 21) and further offset from the radiating element. For example, a center of the aperture (e.g., aligned with a focal axis of the lens substrate) may be offset from a center (e.g., axis of maximum directivity and/or phase center) of the radiating element. For instance, the aperture may be aligned with at least a portion of the radiating element, such as a dipole arm of a dipole radiating element, and the aperture may be offset from at least another portion of the radiating element, such as another dipole arm of the dipole radiating element.

FIG. 6A shows an antenna device 50 having a radiating element 21 that is aligned, in part, with an aperture 29 of the metasurface lens 30 and is further offset from the aperture 29 by an offset distance. In the illustrated example, one half of the dipole is aligned with the aperture 29 and the other half of the dipole is offset from the aperture, so as to align with conductive scattering elements 31, 32, 33, 34 on metasurface lens substrates 24, 25, 26, 27, 28. For instance, the offset distance may be between ¼ wavelength and ½ wavelength may have a diameter substantially the size of the dipole radiating element 21 (e.g., approximately 0.5 wavelengths. The illustrated aperture 29, shown devoid of conductive scattering elements, may be centered at the focal axis of the lens, resulting in an offset between the focal axis of the lens and an axis of maximum directivity (and/or phase center) of the radiating element 21.

In the configuration shown in FIG. 6A, the offset results in more phase shift being applied to one arm of the dipole than the other, similar to the configuration of FIG. 5A, and as a result, a radiation pattern 52 in FIG. 6B shows high gain, narrow beamwidth with low sidelobes that is tilted to the right of boresight. In FIG. 6A, a succession of curved wavefronts 23 are shown corresponding to electromagnetic waves that propagate away from the radiating element 21 and through the metasurface lens substrates 24, 25, 26, 27, 28, resulting in an angled but substantially flattened curvature wavefront 51 as it exits the lens.

If the radiating element 21 were instead on the opposite side of the aperture 29 (e.g., on an opposite side of the focal axis of the lens 30), the radiation pattern of the beam would be pointed in an opposite direction to the configuration 50 shown in FIG. 6A (e.g., corresponding to a −13° tilt). On the other hand, if the offset distance were increased (e.g., with radiating element 21 farther away from the aperture 29 and focal axis of the lens 30), the radiation pattern would still produce a tilt but the gain and sidelobes may degrade in some cases. For example, some arrangements of conductive scattering elements may not be as effective when aligned with both sides of the radiating element arms,, and/or the distance between the phase center of the radiating element to the focal axis of the lens may become too large for the particular lens design. However, in other cases, the conductive scattering elements 31, 32, 33, 34 may be arranged to provide improved radiation pattern performance over a wider scan angle than shown in FIG. 6A.

In some embodiments, the aperture 29 (e.g., devoid of scattering elements) may advantageously provide high gain at boresight when an axis of maximum directivity (and/or phase center) of the radiating element 21 is aligned with the focal axis of the lens 30, and/or when the offset distance is between one-quarter (¼) wavelength and one-half (½) wavelength, so as to steer the beam off boresight.

Although the aperture 29 is shown devoid of scattering elements, inclusion of conductive scattering elements (e.g., effecting less phase shift than surrounding conductive scattering elements) may alternatively or additionally be applied to the lens substrates.

In some embodiments, an antenna device may include a lens substrate having an aperture that is aligned in part with, and offset from, multiple radiating structures. For example, the aperture may be aligned with the radiating structures in a direction in which the radiating structures are configured to transmit and/or receive electromagnetic waves and offset from the radiating structures in different respective directions. For instance, centers of the radiating structures (e.g., axes of maximum directivity and/or phase centers thereof) may be offset in different directions from a center of the aperture (e.g., aligned with a focal axis of the lens). In some embodiments, multiple radiating structures aligned at least in part with and offset from an aperture of a lens substrate facilitates flexible operation of the antenna device, such as using the radiating structures selectively and/or in combination to produce a desired beam shape and/or steer transmission or reception in a particular direction.

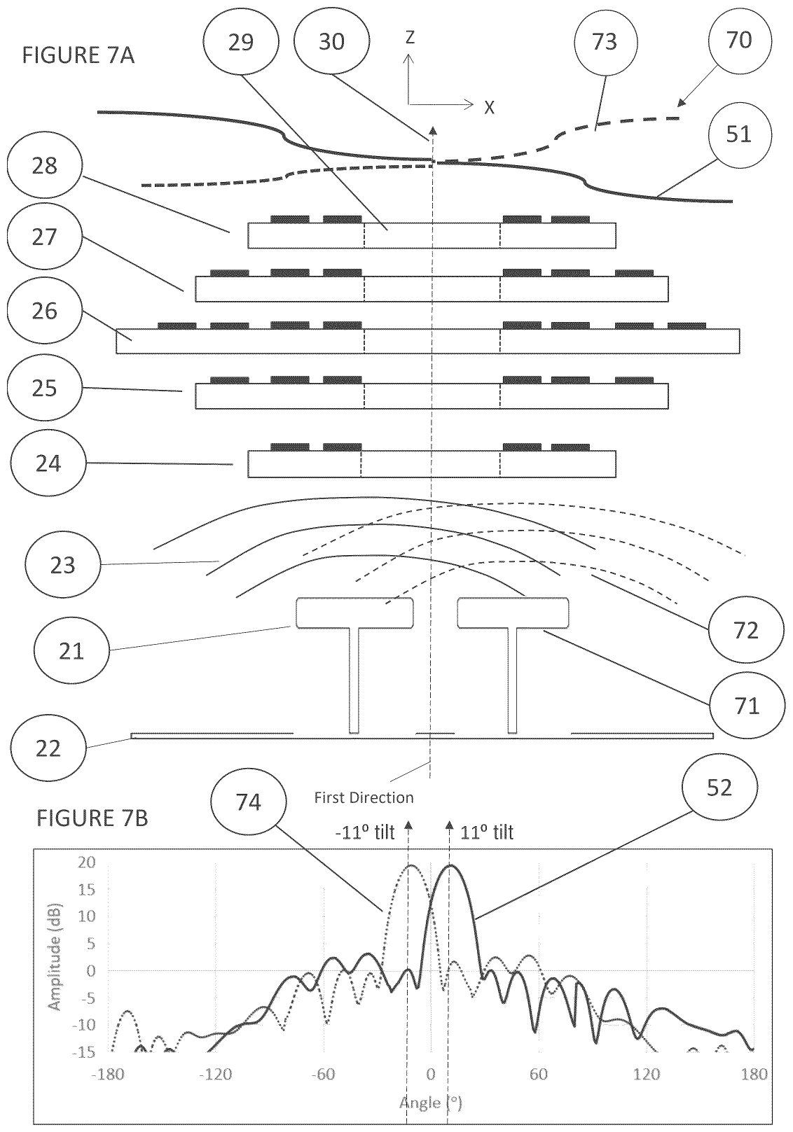

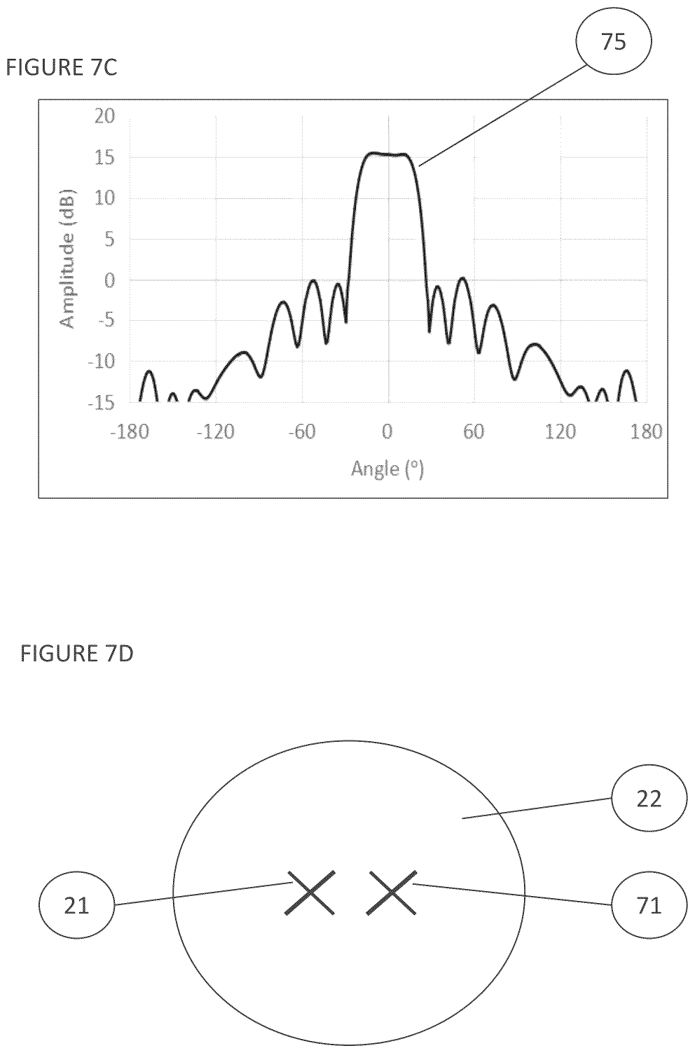

FIG. 7A shows a representation of the input and output wavefronts of two radiating elements excited concurrently and separated equally in opposite directions from the focal axis of the lens, according to one or more non-limiting embodiments of the present disclosure.

FIG. 7B shows resulting radiation patterns of FIG. 7A including two output beams with one tilted at +11° and one tilted at −11° off axis, according to one or more non-limiting embodiments of the present disclosure.

In FIG. 7A, an antenna device 70 is shown in which an aperture 29 of the lens substrates 24, 25, 26, 27, 28 is aligned in part with, and offset from, multiple radiating elements 21 and 71. As shown in FIG. 7A, the aperture 29 is offset from the radiating elements 21 and 71 in different respective directions, with the radiating element 21 centered at a first side with respect to the aperture 29 and with the radiating element 71 centered at a second side with respect to the aperture 29. In the illustrated example, the offset distances between centers of the radiating elements and a center of the aperture are the same, but may be different in some embodiments.

In FIG. 7A, a succession of emerging curved wavefronts 72 are excited in radiating element 71 concurrently with radiating element 21 having a succession of emerging curved wavefronts 23. After exiting the metasurface lens substrates 24, 25, 26, 27, 28, the output of the emerging wavefronts 73 and 51 respectively are at different angles to each other resulting in patterns 74 pointing at an angle of −11° and radiation pattern 52 pointing at an angle of +11°.

In some embodiments, electromagnetic waves transmitted and/or received via radiating elements that are aligned in part with, and offset from, an aperture of a lens substrate may be combined to produce a desired beam shape. For example, FIG. 7C shows a radiation pattern plot 75 with a substantially flat top and very sharp rolloff. Such a radiation pattern shape may be advantageous for placing beams very close together due to the sharp rolloff to reduce interference between adjacent cells. The radiation pattern 75 may be obtained by combining the radiation pattern of 74 and the radiation pattern of 52, for example, through a power combiner.

FIG. 7D shows a top view of the layout of the radiating elements 21, 71 over ground plane 22.

While two radiating elements are shown in FIG. 7A, any number of radiating elements may be configured as described herein for the configuration of FIG. 7A. Moreover, while the radiating elements 21 and 71 in FIG. 7A are spaced from one another in the same directions in which the aperture 29 is offset from the respective radiating elements 21 and 71, that the directions in which the radiating elements are spaced from one another and the directions in which the aperture is offset from the respective radiating elements may be different.

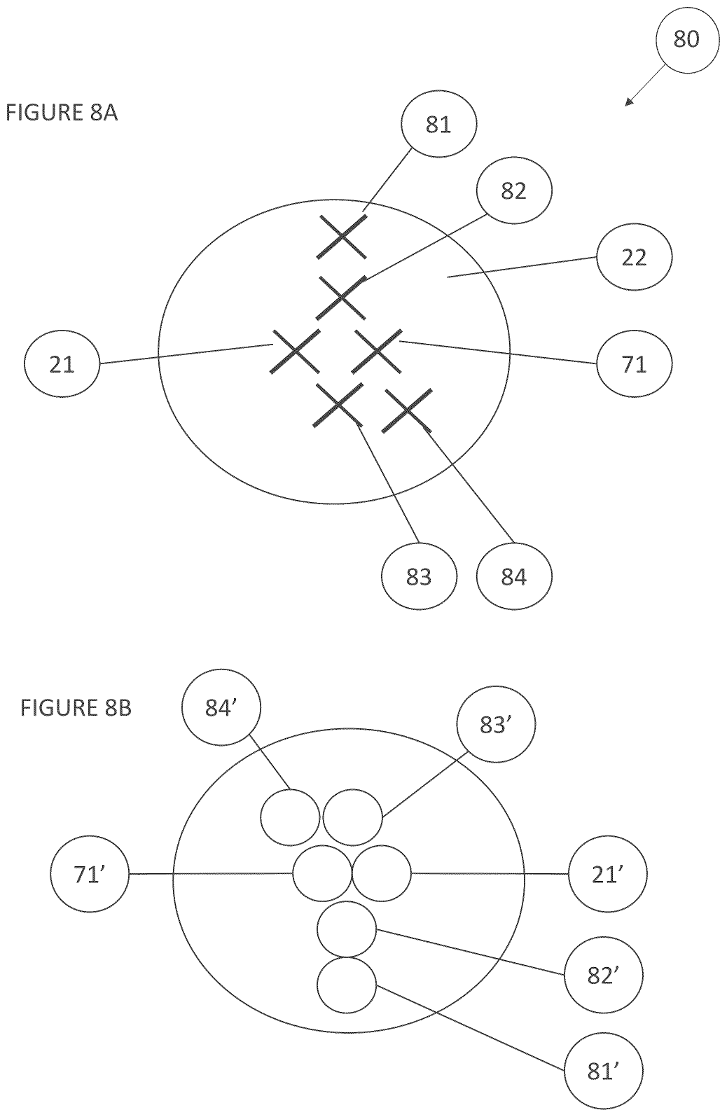

FIG. 8A shows a top view of an arrangement of dipoles 80 and FIG. 8B shows their corresponding spot (e.g., pencil) beams resulting from application of a metasurface lens (e.g., as in FIG. 7A). For example, radiating element 21 above a ground plane 22 and below the metasurface lens may generate a spot beam 21′. Radiating element 71 above a ground plane 22 and below the metasurface lens may generate a corresponding spot beam 71′. Radiating element 84 above a ground plane 22 and below the metasurface lens may generate a spot beam 84′. Similarly, radiating elements 81, 82, and 83 above the ground plane 22 and below the metasurface lens may generate corresponding spot beams 81′, 82′ and 83′ respectively. As shown in FIG. 8B, the spot beams may be angled with respect to the locations of the corresponding dipoles 80 as a result of the metasurface lens. For example, since the aperture of the lens (e.g., centered at a focal axis of the lens) may be offset from the dipoles 80, the conductive scattering elements of the lens may be configured to steer electromagnetic waves to and/or from the dipoles 80 at different angles corresponding to their respective offsets. In some embodiments, an antenna device having multiple radiating elements (e.g., as in FIG. 8A) may be selectively excited to steer transmission and/or reception in a direction and/or with a beam shape that depends on the selected radiating elements.

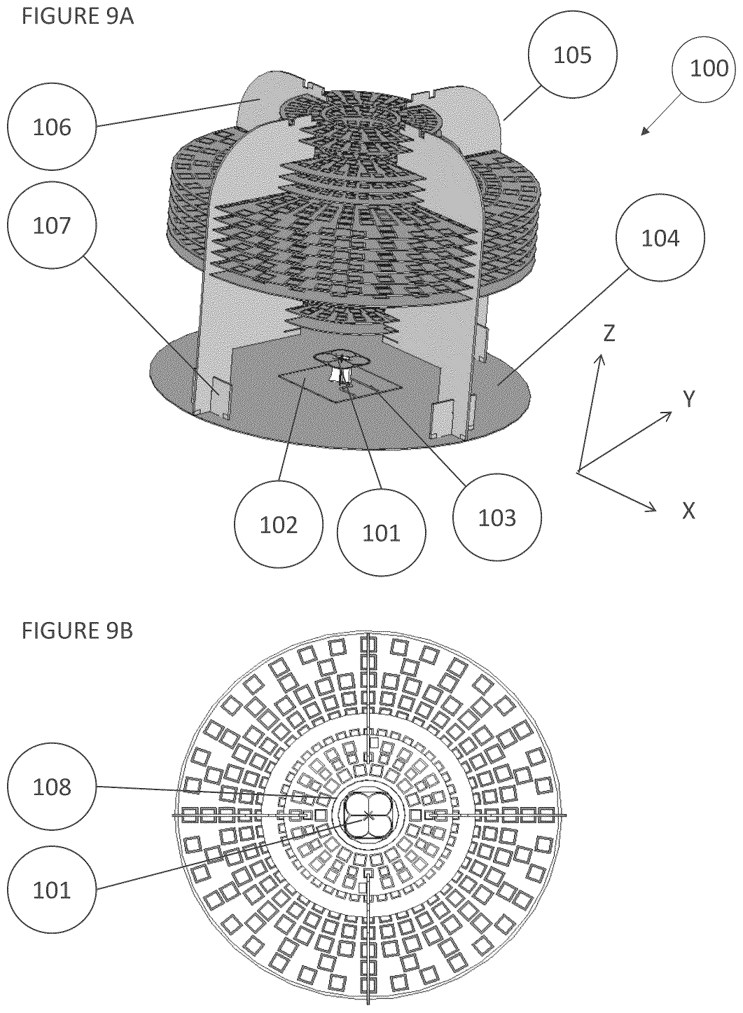

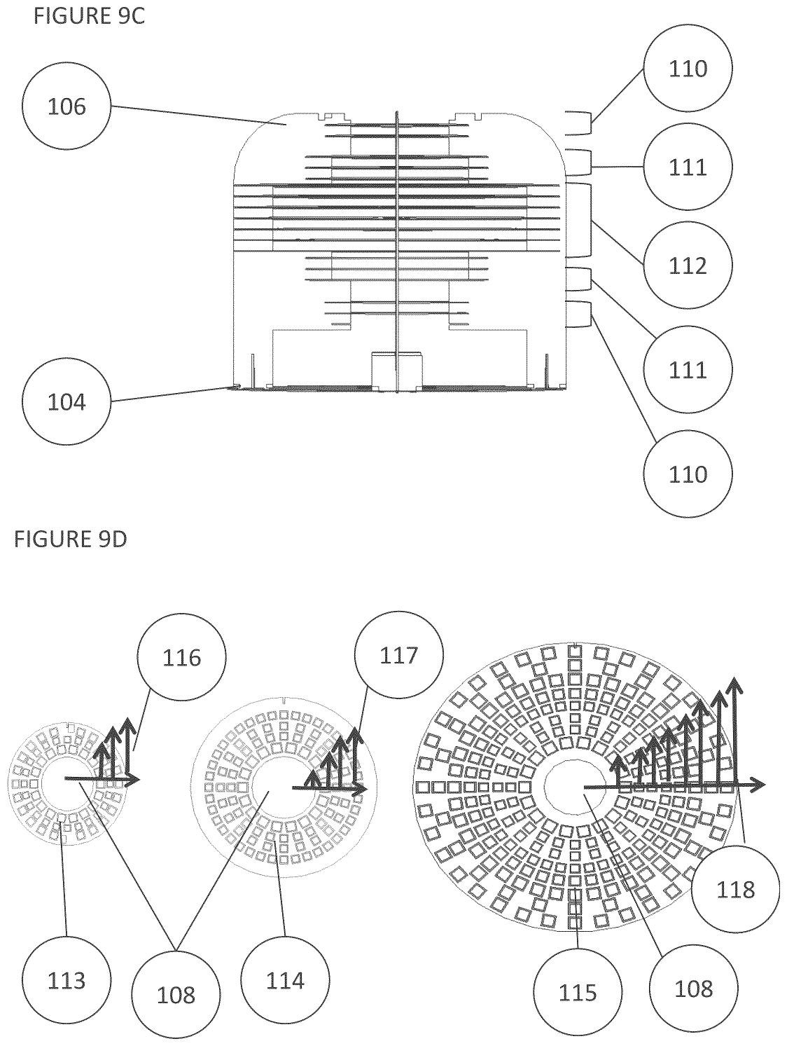

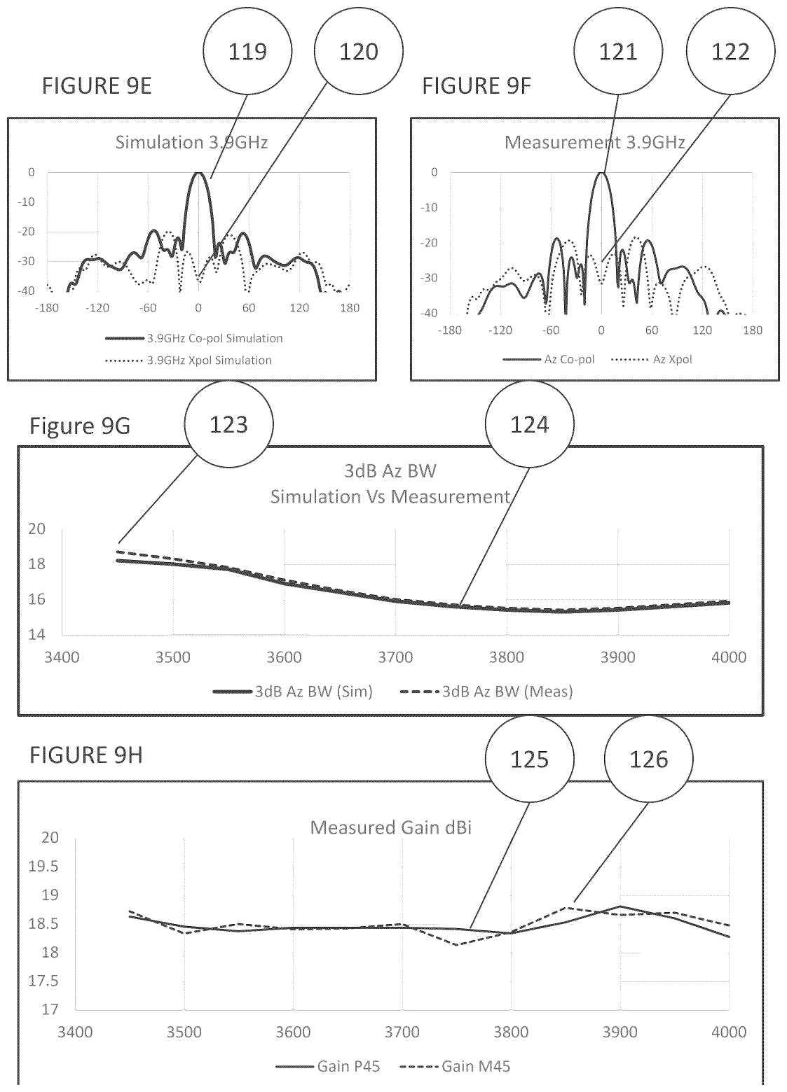

FIG. 9A shows an antenna configuration 100 that may be configured to operate across a frequency band of 3300-4000 MHz (e.g., 3450-4000 MHz) to achieve a narrow beamwidth, low sidelobe and high gain 3-dimensional (3D) metasurface lens antenna for high capacity sites like sports stadiums. The antenna configuration 100 comprises a radiating element 101 fed by a microstrip line 103 on a microwave quality Taconic material 102 with a dielectric constant DK=2.55. The antenna configuration 100 is positioned on a large metal reflector 104. An array of metasurface lens substrates with each lens substrate having conductive scattering elements etched on a 30 mil (0.76 mm) FR4 PCB material are spaced one after another to form a 3D layered metasurface lens assembly 105 configured to focus the energy to and/or from the top of the radiating element 101. Each FR4 metasurface lens substrate may be supported by FR4support structures 106 with bracing tabs 107 to provide structural integrity for the 3D metasurface lens.

FIG. 9B shows a top view of the antenna configuration 100 showing the large open aperture devoid of conductive scattering elements 108, through which the radiating element 101 is substantially or totally visible.

FIG. 9C shows a side view of the antenna configuration 100. The side view further illustrates several layers of the 3D layered metasurface lens assembly 105. The assembly as shown in FIG. 9C includes the following layers:
Layers 110 at the top and bottom of the assembly each include two metasurface lens substrates 113 with each of the two lens substrates separated by a distance of 0.1 wavelength or 8 mm at 3800 MHz.
Layers 111 are below and above the top and bottom layers 110, respectively, and each includes three metasurface lens substrates 114 with each lens substrate separated by a distance of 0.1 wavelength or 8 mm at 3800 MHz.
Layers 110 are separated from Layers 111 by 0.19 wavelengths or 15 mm at 3800 MHz.
Layer 112 is between layers 111 and includes 7 metasurface lens substrates 115 with each lens substrate separated by a distance of 0.1 wavelength or 8 mm at 3800 MHz.

The distance from the top of the reflector 104 to the first metasurface lens layer 110 is 0.7 wavelengths or 55 mm at 3800 MHz.

It should be appreciated that distances and layer configurations shown in FIG. 9C vary depending on the desired phase shift configuration, performance, and available space.

FIG. 9D shows a top view of each type of metasurface lens substrate of FIG. 9C, illustrating the conductive scattering element arrangement for each lens substrate.

Metasurface lens substrate 113 has three concentric circular rings of conductive scattering elements 116.

Metasurface lens substrate 114 has four concentric circular rings of conductive scattering elements 117.

Metasurface lens substrate 115 has eight concentric circular rings of conductive scattering elements 118.

It should be appreciated that other shapes of concentric rings and/or numbers of conductive scattering elements may be used, depending on the desired phase shift and/or available space in the antenna device.

FIG. 9E shows simulated co-polarized radiation pattern plot 119 and cross polarized radiation pattern plot 120 at 3900 MHz or 3.9GHz.

FIG. 9F shows measured co-polarized radiation pattern plot 121 and cross polarized radiation pattern plot 122 at 3900 MHz or 3.9 GHz.

FIG. 9G shows simulated 3 dB azimuth beamwidth across frequency 123 and measured 3 dB azimuth beamwidth across frequency 124.

FIGS. 9E to 9G show a good correlation between simulation and measurement data.

FIG. 9H shows the measured gain of the antenna configuration 100. An average gain of 18.5 dBi is achieved for the example configuration for both +45° polarization 125 and −450 polarization 126.

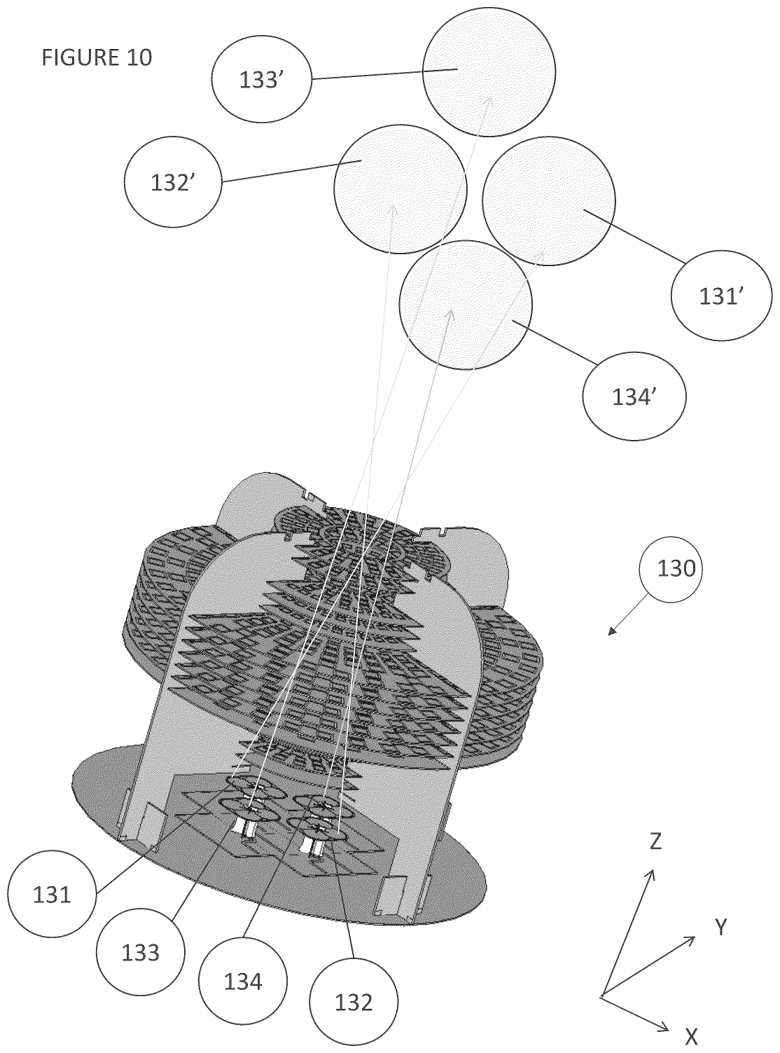

FIG. 10 shows an example antenna configuration 130 that operates across a frequency band of 3300-4000 MHz for high capacity sites like sports stadiums that can output four (or more) concurrent beams with narrow beamwidths, low sidelobes and high gain. In the illustrated configuration, radiating element 131 produces spot beam 131′, radiating element 132 produces spot beam 132′, radiating element 133 produces spot beam 133′ and radiating element 134 produces spot beam 134′. In the illustrated configuration, each radiating element is aligned with and offset from an aperture of the metasurface lens substrates, such as described herein in connection with FIG. 7A. For example, radiating elements 131-134 may be selectively excited to steer and/or shape transmission and/or reception of electromagnetic waves depending on the number of and particular radiating elements selected.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including”, “comprising”, “having”, “containing” or “involving” and variations thereof herein, is meant to encompass the items listed thereafter and equivalents thereof as well as additional items.

The terms “approximately”, “substantially,” and “about” may be used to mean within ±20% of a target value in some embodiments, within ±10% of a target value in some embodiments, within ±5% of a target value in some embodiments, and within ±2% of a target value in some embodiments. The terms “approximately” and “about” may include the target value.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The descriptions of the various embodiments have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. An antenna device, comprising:
a first radiating structure configured to transmit and/or receive electromagnetic waves in a first direction;
a second radiating structure spaced from the first radiating structure in a second direction perpendicular to the first direction and configured to transmit and/or receive electromagnetic waves in the first direction; and
a lens substrate spaced from the first radiating structure and from the second radiating structure in the first direction and comprising:
an aperture therein aligned, at least in part, with the first radiating structure along the first direction and aligned, at least in part, with the second radiating structure along the first direction; and
a surface having conductive material thereon configured to apply a phase shift to electromagnetic waves to and/or from the first radiating structure and to and/or from the second radiating structure passing therethrough.

2. The antenna device of claim 1, wherein:
the aperture is aligned, in part, with the first radiating structure along the first direction and offset from the first radiating structure along a third direction that is perpendicular to the first direction; and
the aperture is aligned, in part, with the second radiating structure along the first direction and offset from the second radiating structure along a fourth direction that is perpendicular to the first direction.

3. The antenna device of claim 2, wherein:
the first radiating structure and the second radiating structure are configured to transmit and/or receive electromagnetic waves at a first frequency;
a center of the aperture is offset from a center of the first radiating structure in the third direction by a first offset distance that is at least one-quarter wavelength at the first frequency and less than one-half wavelength at the first frequency; and
the center of the aperture is offset from a center of the second radiating structure in the fourth direction by a second offset distance that is at least one-quarter wavelength at the first frequency and less than one-half wavelength at the first frequency.

4. The antenna device of claim 3, wherein the aperture has a diameter between 0.4 wavelengths and 0.6 wavelengths at the first frequency.

5. The antenna device of claim 1, wherein the aperture comprises a void in the lens substrate.

6. The antenna device of claim 1, wherein the conductive material comprises conductive elements configured to apply respective phase shifts to electromagnetic waves passing through the conductive material, the phase shifts increasing with distance from the conductive element to the aperture.

7. The antenna device of claim 1, wherein:
the first radiating structure is configured to transmit and/or receive electromagnetic waves along a first axis in the first direction;
the second radiating structure is configured to transmit and/or receive electromagnetic waves along a second axis in the first direction;
the conductive material is configured to apply the phase shift to steer the electromagnetic waves transmitted and/or received by the first radiating structure at a first angle with respect to the first axis; and
the conductive material is configured to apply the phase shift to steer the electromagnetic waves transmitted and/or received by the second radiating structure at a second angle with respect to the second axis.

8. The antenna device of claim 1, further comprising:
a second lens substrate spaced from the lens substrate in the first direction and comprising:
a second aperture therein aligned, at least in part, with the first radiating structure along the first direction and aligned, at least in part, with the second radiating structure along the first direction; and
a second surface having conductive material thereon configured to apply a phase shift to electromagnetic waves to and/or from the first radiating structure and to and/or from the second radiating structure passing therethrough.

9. An antenna device, comprising:
a radiating structure configured to transmit and/or receive electromagnetic waves in a first direction;
a first lens substrate spaced from the radiating structure in the first direction and comprising:
a first aperture therein aligned, at least in part, with the radiating structure along the first direction; and
a first surface having conductive material thereon configured to apply a phase shift to electromagnetic waves to and/or from the radiating structure passing therethrough; and
a second lens substrate spaced from the first lens substrate in the first direction and comprising:
a second aperture therein aligned, at least in part, with the radiating structure along the first direction; and
a second surface having conductive material thereon configured to apply a phase shift to electromagnetic waves to and/or from the radiating structure passing therethrough.

10. The antenna device of claim 9, wherein the first aperture comprises a void in the first lens substrate and the second aperture comprises a void in the second lens substrate.

11. The antenna device of claim 9, wherein:
the conductive material on the first surface comprises conductive elements configured to apply respective phase shifts to electromagnetic waves passing through the conductive material, the phase shifts increasing with distance from the conductive element to the first aperture; and
the conductive material on the second surface comprises conductive elements configured to apply respective phase shifts to electromagnetic waves passing through the conductive material, the phase shifts increasing with distance from the conductive element to the second aperture.

12. The antenna device of claim 11, wherein:
the conductive material on the second surface comprises more conductive elements than the conductive material on the first surface.

13. The antenna device of claim 11, wherein:
the conductive elements of the conductive material on the first surface are arranged in a first plurality of rings that are concentric with the first aperture;
the conductive elements of the conductive material on the second surface are arranged in a second plurality of rings that are concentric with the second aperture; and
the second plurality of rings are greater in number than the first plurality of rings.

14. The antenna device of claim 11, further comprising:
a third lens substrate spaced from the second lens substrate in the first direction and comprising:
a third aperture therein aligned, at least in part, with the radiating structure along the first direction; and
a third surface having conductive material thereon that comprises conductive elements configured to apply respective phase shifts to electromagnetic waves passing through the conductive material, the phase shifts increasing with distance from the conductive element to the third aperture,
wherein the conductive material on the second surface comprises more conductive elements than the conductive material on the third surface.

15. An antenna device, comprising:
a radiating structure configured to transmit and/or receive electromagnetic waves in a first direction; and
a lens substrate spaced from the radiating structure in the first direction and comprising:
an aperture therein aligned, in part, with the radiating structure along the first direction and offset, in part, from the radiating structure in a second direction perpendicular to the first direction; and
a surface having conductive material thereon configured to apply a phase shift to electromagnetic waves to and/or from the radiating structure passing therethrough.

16. The antenna device of claim 15, wherein:
the radiating structure is configured to transmit and/or receive electromagnetic waves along a first axis in the first direction; and
the conductive material is configured to apply the phase shift to steer the electromagnetic waves at an angle with respect to the first axis.

17. The antenna device of claim 15, wherein:
the radiating structure is configured to transmit and/or receive electromagnetic waves at a first frequency;
a center of the aperture is offset from a center of the radiating structure in the second direction by an offset distance that is at least one-quarter wavelength at the first frequency and less than one-half wavelength at the first frequency; and
the aperture has a diameter between 0.4 wavelengths and 0.6 wavelengths at the first frequency.

18. The antenna device of claim 15, wherein the aperture comprises a void in the lens substrate.

19. The antenna device of claim 15, wherein the conductive material comprises conductive elements configured to apply respective phase shifts to electromagnetic waves passing through the conductive material, the phase shifts increasing with distance from the conductive element to the aperture.

20. The antenna device of claim 15, further comprising:
a second lens substrate spaced from the lens substrate in the first direction and comprising:
a second aperture therein aligned, in part, with the radiating structure along the first direction and offset, in part, from the radiating structure in the second direction; and
a second surface having conductive material thereon configured to apply a phase shift to electromagnetic waves to and/or from the radiating structure passing therethrough.
